(19) United States
(12) Patent Application Publication
(10) Pub. No.: US 2017/0236291 A1
(43) Pub. Date: Aug. 17, 2017

(54) DRONE INCLUDING A FRONT-VIEW CAMERA WITH ATTITUDE-INDEPENDENT CONTROL PARAMETERS, IN PARTICULAR AUTO-EXPOSURE CONTROL

(71) Applicant: PARROT DRONES, Paris (FR)

(72) Inventors: Axel Balley, Paris (FR); Benoit Pochon, Vincennes (FR)

(21) Appl. No.: 15/256,423

(22) Filed: Sep. 2, 2016

(30) Foreign Application Priority Data
Sep. 10, 2015 (FR) 1558420

(51) Int. Cl. G06T 7/11; H04N 5/235; H04N 9/73; G05D 1/00; G06T 5/00; G06K 9/46; B64C 39/02; B64D 47/08; H04N 7/18; H04N 5/232

(52) U.S. Cl. CPC G06T 7/11; H04N 7/185; H04N 5/2351; H04N 9/73; H04N 5/23212; H04N 5/23238; G06T 5/006; G06K 9/4604; B64C 39/024; B64D 47/08; G05D 1/0038; G05D 1/0094; B64C 2201/127

(57) ABSTRACT

The drone comprises a camera (14), an inertial unit (46) measuring the drone angles, and an extractor module (52) delivering image data of a mobile capture area of reduced size dynamically displaced in a direction opposite to that of the angle variations measured by the inertial unit. Compensator means (52) receive as an input the current drone attitude data and acting dynamically on the current value (54) of an imaging parameter such as auto-exposure, white balance or autofocus, calculated as a function of the image data contained in the capture area.

The invention relates to the processing of digital images captured by a camera on board a remote-piloted mobile device, hereinafter “drone”, in particular in a motorized flying vehicle such as a flying drone or UAV (Unmanned Aerial Vehicle).

The invention is however not limited to the images collected by flying devices; it also applies to rolling devices moving on the ground under the control of a remote operator, or floating devices moving on a water area, the term “drone” having to be understood in its most general meaning.

The invention advantageously applies to the images collected by the front camera of a rotary-wing drone such as a quadricopter.

The AR.Drone 2.0 or the Bebop Drone of Parrot SA, Paris, France, are typical examples of such quadricopters. They are equipped with a series of sensors (accelerometers, 3-axis gyrometers, altimeters), a front camera capturing an image of the scene towards which the drone is directed, and a vertical-view camera capturing an image of the overflown ground. They are provided with multiple rotors driven by respective motors, which can be controlled in a differentiated manner so as to pilot the drone in attitude and speed. Various aspects of such drones are described in particular in the WO 2010/061099 A2, EP 2 364 757 A1, EP 2 613 213 A1 or EP 2 613 214 A1 (Parrot SA).

An article of Timothy McDougal, published on Internet, entitled “The New Parrot Bebop Drone: Built for Stabilized Aerial Video” dated from 06.10.2014 (XP055233862), describes in particular the above-mentioned Bebop Drone device, which is a drone provided with a fisheye lens associated with an image stabilization and control system.

The front video camera can be used for an “immersive mode” piloting, i.e. where the user uses the image of the camera in the same way as if he was himself on board the drone. It may also serve to capture sequences of images of a scene towards which the drone is directed. The user can hence use the drone in the same way as a camera or a camcorder that, instead of being held in hand, would be borne by the drone. The images acquired can be recorded then broadcast, put online on video sequence hosting web sites, sent to other Internet users, shared on social networks, etc.

These images being intended to be recorded and communicated, it is desirable that they have the less defects possible, in particular defects caused by the behaviour of the drone: indeed, any linear displacement of the drone forward, rearward or aside involves a tilting of the drone, and hence an undesirable corresponding effect of shifting, rotation, oscillation . . . of the image acquired by the camera that, in practice, induces various untimely artefacts in the final image displayed to the user.

These defects may be tolerable in an “immersive piloting” configuration. On the other hand, if the matter is to use the drone as a mobile video camera to capture sequences that will be recorded and rendered latter, these defects are extremely troublesome, so that is it desirable to reduce them to a minimum.

In the case of the above-mentioned Bebop Drone, the latter implements a camera provided with a hemispherical-field lens of the fisheye type covering a field of about 180° but only one part of the captured field of which is used, this part roughly corresponding to the angular sector captured by a conventional camera.

For that purpose, a particular window (hereinafter “capture area”) is selected in the overall hemispherical image formed at the surface of the sensor. This window is mobile in rotation and in translation, and permanently displaced as a function of the movements of the drone determined by the inertial unit, and in the opposite direction with respect to these movements. The image acquired by the fisheye lens of course undergoes the same oscillation and rotation movements as a conventional camera, but the displacement of the image area is feedback-controlled so as to compensate for these movements and to hence produce an image stabilized with respect to the drone movements.

The image of the capture area, more exactly a useful part (hereinafter “useful area”) of the latter, is then subjected to a reprojection process to compensate for the geometric distortions introduced by the fisheye lens:

straightening of the straight lines curved by the lens, reestablishment of a uniform magnification between the centre and the periphery of the image, etc. The final image obtained (“straightened useful area”) is then transmitted to the user to be displayed on a screen, recorded, etc.

A “virtual camera” is hence defined by extraction from the total scene captured of a particular area (the capture area) that is dynamically displaced, in rotation and in translation, in the initial image, in the direction opposite to the movements of the drone so as to annihilate the oscillations that would otherwise be observed in the final image displayed to the user, then by application of an image straightening process to obtain a representation of the scene with no geometric nor other distortion.

This technique is described in the EP 2 933 775 A1 (Parrot), published on 21 Oct. 2015.

A comparable technique is also described in the article of Miyauchi R et al., “Development of Omni-Directional Image Stabilization System Using Camera Posture Information”, Proceedings of the 2007 IEEE International Conference on Robotics and Biomimetics, Dec. 15-18, 2007, pp. 920-925 which proposes to apply such an EIS (Electronic Image Stabilization) technique to the image captured by a camera provided with a hemispherical field lens of the “fisheye” type, i.e. covering a field of about 180°. The raw image is acquired in, subjected to a straightening process (to compensate for the fisheye distortions) and then to a process of dynamic windowing as a function of the movements of the robot that carries the camera. The compensation is operated by translation of a capture area to an acquisition area, in the direction opposite to the movement to be compensated for, the sensor transmitting only a sub-part corresponding to the stabilized image.

The present invention aims to eliminate a particular defect that appears during certain movements of the drone.

This defect relates to the dynamic control of a certain number of operation parameters of the camera, i.e. parameters that are automatically adjusted by image analysis algorithms such as the algorithms of auto-exposure (AE, based on an analysis of the brightness of the different points of the image), of automatic white balance (AWB, based on a colorimetric analysis of the different points of the image) or of automatic focusing (AF, based on an analysis of the contrast of the different points of the image).

Examples of AE and AWB algorithms may be found in the US 2015/0222816 A1 and of AF algorithm in the US 2013/0021520 A1.

In the following of the description, it will be taken as a typical particular case the automatic control of the exposure, but the invention is not limited to the control of this parameter and, as will be understood, may be applied to the automatic control of other parameters based on an analysis of the image, such as the white balance and the focusing.

The principle of an auto-exposure (AE) algorithm is to choose for the sensor a couple {time of exposure, gain} making it possible to capture any scene with a same target brightness. This choice is operated based on an analysis of a reduced-definition version of the image (for example, 64×48 pixels), hereinafter “thumbnail”, obtained by sub-sampling or decimation, and from which are extracted brightness histograms as well as, possibly, other parameters, such different start data being hereinafter referred to by the general term of “statistics” of the image.

In the above-described case of a capture area extracted from the overall image collected by the sensor, this is the content of the capture area that produces the statistics serving to calculate the parameters of control of the auto-exposure.

But, as explained hereinabove, this capture area is greater than the final useful area that will be displayed to the user, so that the auto-exposure algorithm can make decisions based on elements of the scene that the user does not see, i.e. elements located inside the capture area but outside the useful area.

Now, the scene that is desired to be correctly exposed is that which is seen by the user (the useful area), and not the capture area, which is different from the latter.

In the example of an image comprising a part of sky and a part of ground, the proportion between sky and ground will vary according to the camera inclination, and hence according to the drone attitude. That way, if the drone passes from a hovering flight attitude to a downwardly inclined attitude (this tilting producing a forward linear displacement), then the camera, inclined towards the ground (because it is linked to the drone body) will capture a far higher proportion of ground. As the ground is darker, the control of the auto-exposure algorithm will tend to compensate for this brightness variation by an increase of the time of exposure and/or of the gain.

However, due to the displacement of the capture area in the initial image and to the reprojection operated to extract therefrom the useful area, the user will always see the same scene. But this scene will be temporarily over-exposed due to the corrective action of the auto-exposure, overexposure that will disappear when the drone will go back to its initial attitude—and without thereby the outlines of the image seen by the user have changed.

Such is the problem that the invention aims to solve.

For that purpose, the invention proposes a drone comprising, in a manner known in itself, in particular from the above-mentioned article of Miyauchi et al.:
a camera linked to the drone body, comprising a hemispheric-field lens of the fisheye type, pointing in a fixed direction with respect to the drone body, a digital sensor collecting the image formed by the lens and delivering raw image data;
an inertial unit, adapted to measure the Euler angles characterizing the instantaneous attitude of the drone with respect to an absolute terrestrial reference system and delivering as an output current drone attitude data;
extractor means, adapted to define, in said image formed over the extent of the sensor, the position of a capture area of reduced size;
control means, receiving as an input the current drone attitude data and adapted to dynamically modify the position and the orientation of the capture area in said image in a direction opposite to that of the changes of values of the angles measured by the inertial unit; and
reprojection means, receiving as an input image data of a user area extracted from the capture area and delivering as an output corresponding straightened image data, compensated for the geometric distortions introduced by the fisheye lens.

Characteristically of the invention, the camera further comprises means for the dynamic control of at least one imaging parameter among auto-exposure, white balance and autofocus, and the drone further comprises:
analysis means, adapted to define in the capture area at least one reduced-definition thumbnail, and to deliver a current value of said imaging parameter as a function of the image data contained in said thumbnail; and
compensator means, such means receiving as an input the current drone attitude data delivered by the inertial unit and being adapted to dynamically interact with the analysis means, as a function of these current attitude data, in a direction opposite to the variations, liable to be caused by the instantaneous variations of attitude of the drone, of said value of the imaging parameter, delivered by the analysis means.

That way, the imaging parameter keeps a value that is substantially independent of the instantaneous variations of attitude of the drone.

Advantageously, the analysis means are further adapted to exclude from said image data contained in the thumbnail coming from the capture area the raw image data that are located outside the region of the image formed by the lens on the sensor.

According to a first embodiment, the compensator means receive as an input the image data comprised in the thumbnail coming from the capture area, delivered by the extractor means, and the analysis means comprise means adapted to define dynamically in each image a plurality of regions of interest ROIs distributed over the capture area with a corresponding thumbnail for each ROI, and to deliver a current value of said imaging parameter for each respective thumbnail. The compensator means then comprise means adapted to interact dynamically with the analysis means by modification of the size and/or position of the ROIs in the capture area as a function of the current drone attitude data.

Advantageously, the compensator means comprise means adapted to previously exclude from the definition of the ROIs those of the ROIs that are located outside the current user area included in the capture area.

The compensator means may in particular comprise means adapted to allocate to each ROI a peculiar weighting value that is function of the more or less great extent of the overlapping of the ROI with the current user area defined inside the capture area, this value being maximum for the ROI entirely included in the current user area and lower for the overlapping ROIs extending both inside and outside the current user area.

The compensator means may also comprise means adapted to allocate to each ROI a peculiar weighting value that is function of the more or less great surface of the ROI.

According to a second embodiment, the compensator means receive as a input the image data comprised in the thumbnail coming from the capture area, delivered by the extractor means, and the analysis means comprise means adapted to define a grid of regions of interest ROIs distributed in a uniform and predetermined manner over the capture area with a corresponding thumbnail for each ROI, and to deliver a current value of said imaging parameter for each respective thumbnail. The compensator means then comprise means adapted to interact dynamically with the analysis means by allocating to each ROI a peculiar weighting value that is function of the extent of the overlapping of the ROI with the current user area defined inside the capture area, this value being maximum for the ROIs included in the current user area, minimum for the ROIs external to the current user area, and intermediate for the overlapping ROIs extending both inside and outside the current user area.

According to a third embodiment, the compensator means receive as a input the straightened image data, compensated for the geometric distortions introduced by the fisheye lens, delivered by the reprojection means.

In this case, the analysis means may in particular comprise means adapted to define dynamically in each image a plurality of regions of interest ROIs distributed over the straightened image with a corresponding thumbnail for each ROI, and to deliver a current value of said imaging parameter for each respective thumbnail. The compensator means then comprise means adapted to interact dynamically with the analysis means by modification of the size and/or position of the ROIs in the straightened image as a function of the current drone attitude data.

An example of implementation of the present invention will now be described, with reference to the appended drawings in which the same references denote identical of functionally similar elements throughout the figures.

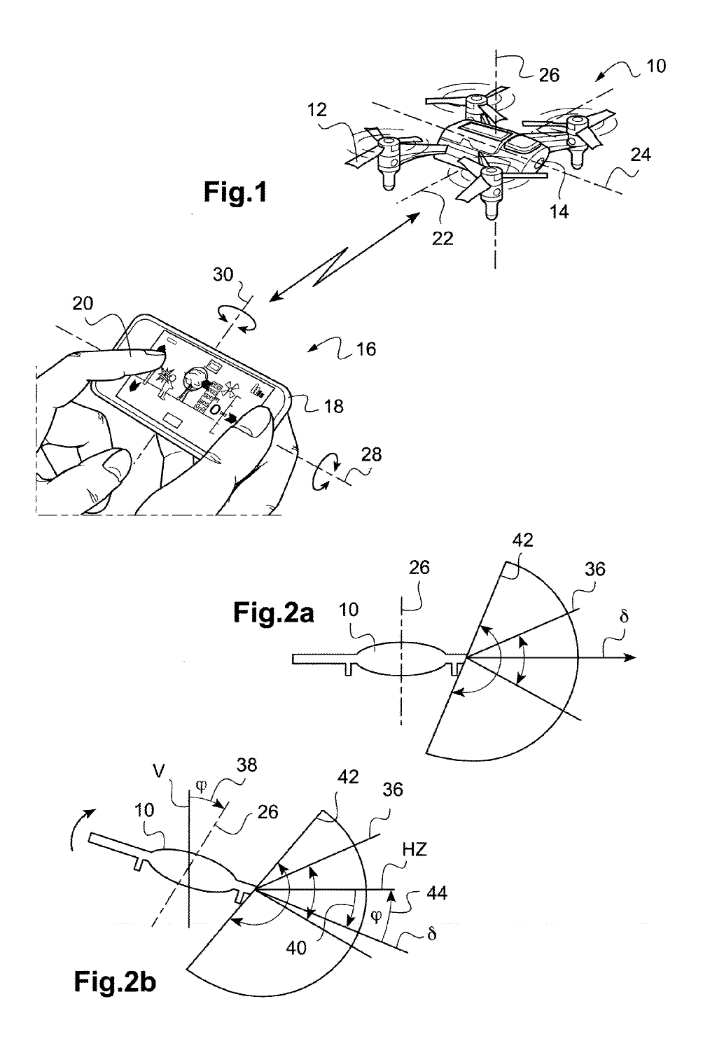

FIG. 1 is an overall view showing the drone and the associated remote-control device allowing the remote piloting thereof.

FIGS. 2a and 2b illustrate the modifications of the viewing directions of the camera caused by a forward tilting of the drone, for example during a phase of acceleration.

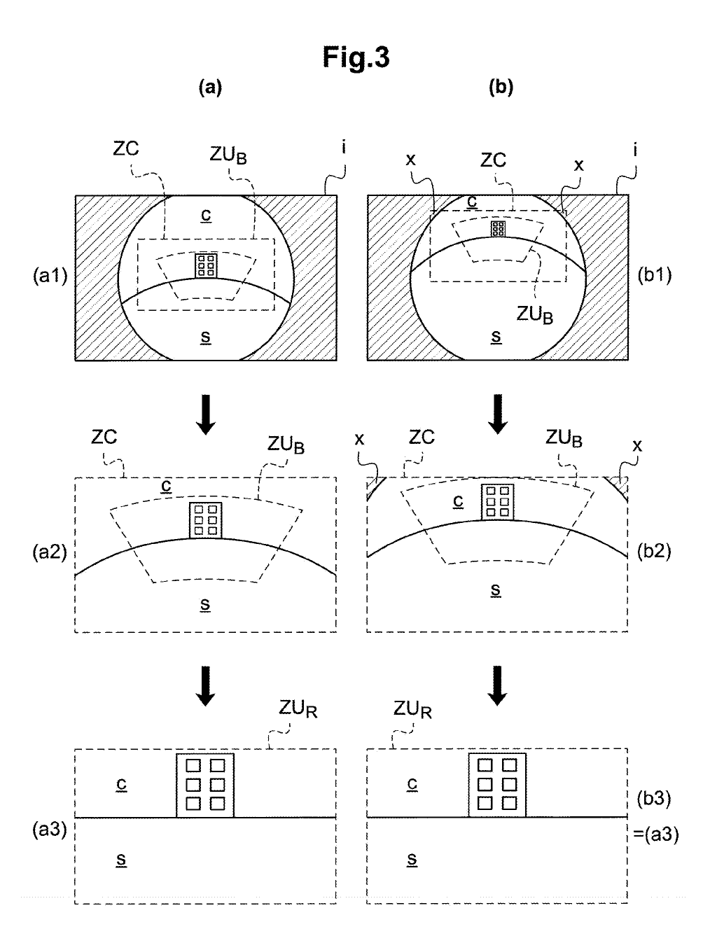

FIG. 3 illustrates in (a1)-(a3) the successive steps of windowing and correction of the distortions applied to the image formed on the sensor of the drone camera so as to produce a straightened image, and in (b1)-(b3) the corresponding steps when the drone attitude is modified, with the camera inclined towards the ground.

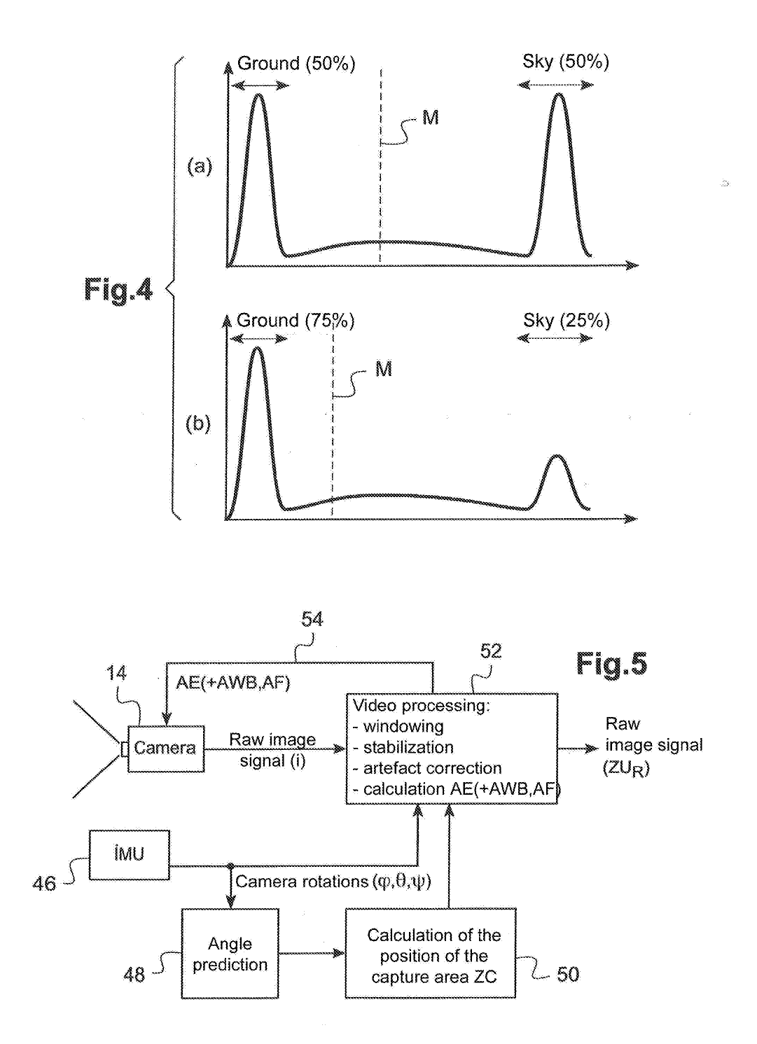

FIG. 4 illustrates in (a) and (b) the brightness histograms obtained by analysis of the capture areas (a2) and (b2), respectively, of FIG. 3.

FIG. 5 illustrates as a block diagram the different modules participating to the implementation of the invention.

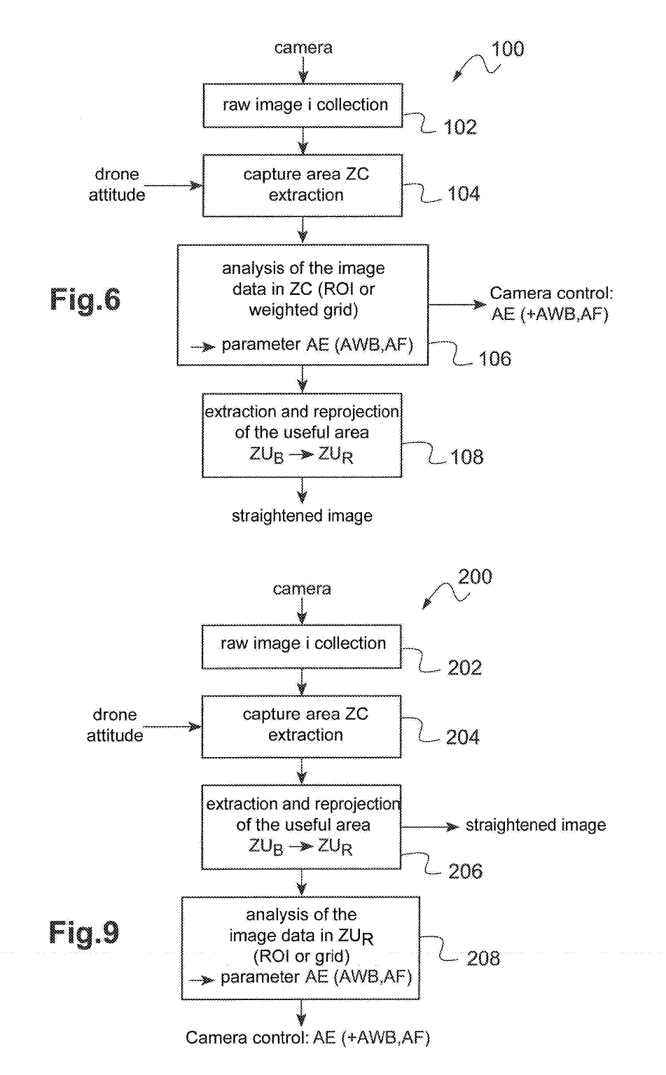

FIG. 6 is a flow diagram explaining the main successive steps of implementation of the invention, in a first and a second embodiment of the latter.

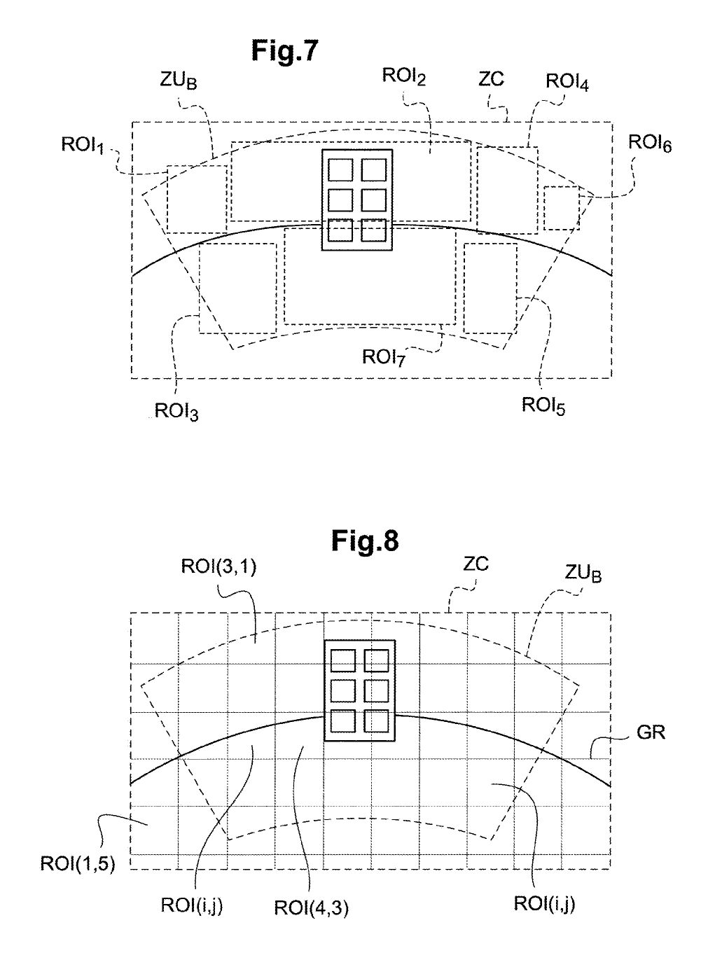

FIG. 7 illustrates the analysis areas of the capture area according to the first embodiment of the invention, based on regions of interest defined automatically inside this capture area.

FIG. 8 illustrates the analysis areas of the capture area according to the second embodiment of the invention, based on the making of a grid in this capture area.

FIG. 9 is a flow diagram explaining the main successive steps of implementation of the invention, in a third embodiment of the latter.

Examples of implementation of the present invention will now be described.

In FIG. 1, the reference 10 generally denotes a drone, which is for example a quadricopter such as the model Bebop Drone of Parrot SA, Paris, France. This drone includes four coplanar rotors 12 whose motors are piloted independently from each other by an integrated navigation and attitude control system. It is provided with a front-view camera 14 permitting to obtain an image of the scene towards which the drone is directed.

The drone also includes a vertical view camera (not shown) pointing downward, adapted to capture successive images of the overflown land and used in particular to evaluate the speed of the drone with respect to the ground. Inertial sensors (accelerometers and gyrometers) permit to measure with a certain accuracy the angular speeds and the attitude angles of the drone, i.e. the Euler angles (pitch φ, roll θ and yaw ψ) describing the inclination of the drone with respect to a horizontal plane in a fixed terrestrial reference system. An ultrasound telemeter arranged under the drone moreover provides a measurement of the altitude with respect to the ground.

The drone 10 is piloted by a remote-control device 16 provided with a touch screen 18 displaying the image on board the front camera 14, with in superimposition a certain number of symbols allowing the activation of piloting commands by simple contact of a user's finger 20 on the touch screen 18. The device 16 is provided with means for radio link with the drone, for example of the Wi-Fi (IEEE 802.11) local network type, for the bidirectional exchange of data from the drone 10 to the device 16, in particular for the transmission of the image captured by the camera 14, and from the device 16 to the drone 10 for the sending of piloting commands.

The remote-control device 16 is also provided with inclination sensors permitting to control the drone attitude by imparting to the device corresponding inclinations about the roll and pitch axes, it being understood that the two longitudinal and transverse components of the horizontal speed of the drone 10 will be closely linked to the inclination about the two respective pitch and roll axes. The piloting of the drone consists in making it evolve by:
a) rotation about a pitch axis 22, to make it move forward or rearward;
b) rotation about a roll axis 24, to shift it to the right or to the left;
c) rotation about a yaw axis 26, to make the main axis of the drone pivot to the right or to the left; and
d) translation downward or upward by changing the gas control, so as to reduce or increase, respectively, the altitude of the drone.

When these piloting commands are applied by the user from the remote-control device 16, the commands a) and b) of pivoting about the pitch 22 and roll 24 axes are obtained by inclinations of the device 16 about its longitudinal axis 28 and its transverse axis 30, respectively: for example, to make the drone move forward, it is just needed to incline the remote-control device 16 forward by tilting it about the axis 28, to move it aside to the right, it is just needed to incline the remote-control device 16 by tilting it to the right about the axis 30, etc. The commands c) and d) themselves result from actions applied by contact of the user's finger 20 on corresponding specific areas of the touch screen 18.

The drone has also an automatic and autonomous system of hovering flight stabilization, activated in particular as soon as the user removes his finger from the touch screen of the device, or automatically at the end of the take-off phase, or in case of interruption of the radio link between the device and the drone.

FIG. 2a schematically illustrates, in profile, the attitude of the drone when the latter is stationary, in a lift condition.

The field covered by a front camera 14 of the conventional type, for example a camera covering a field of 54° and whose sight axis δ is centred to the horizon, is schematized in 36.

If, as illustrated in FIG. 2b, the drone moves forward with a non-zero horizontal speed, by design, the axis 26 of the drone will be inclined forward by an angle φ (pitch angle) with respect to the vertical V. This forward inclination, schematized by the arrow 38, involves an inclination of same value, schematized by the arrow 40, of the axis δ of the camera with respect to the plane of the horizon HZ. It is hence understood that, over the evolutions of the drone, the accelerations, decelerations thereof, etc., the axis δ oscillates permanently about the direction of the horizon HZ, which will translate in the image into permanent upward and downward oscillation movements.

Comparably, if the drone moves aside to the right or to the left, this movement will be accompanied by a pivoting about the roll axis 24, which will translate in the image into rotations in one direction or the other of the scene captured by the camera.

To compensate for these drawbacks, it has been proposed, as explained in the above-mentioned EP 2 933 775 A1 (published on 21 Oct. 2015), to provide the camera with a hemispherical-field lens of the fisheye type covering a field of about 180° as schematized in 42 in FIG. 2a. The image captured by the camera provided with this fisheye lens will of course be subjected to the same oscillation and rotation movements as a conventional camera but only a part of the field captured by this camera will be used by selecting a particular window corresponding to the angular sector 36 captured by a conventional camera, and that will be dynamically displaced in the hemispherical image in the direction opposite to the movements of the drone as determined by the inertial central, so as to annihilate the oscillations that would otherwise be observed in the image.

Hence, in the case illustrated in FIG. 2b, where the drone dives downward by a pitch angle φ (arrow 38) with respect to the vertical V, the capture window will be displaced upward (arrow 44) by an angle of same value, hence returning back towards the horizon HZ the central axis of the sector 36 of a “virtual camera” covering the field corresponding to the image area.

The problem of the invention will now be described with reference to FIG. 3.

FIG. 3 shows in (a1) an example of scene, as collected by the sensor of the video camera provided with the fisheye lens.

As can be observed, the image I of this scene includes very strong geometric distortions, inherent to the hemispheric or quasi-hemispheric coverage of the fisheye lens, straightened on the planar surface of the sensor. Only a part of this image I produced by the fisheye lens will be used. This part is determined as a function i) of the direction in which the “virtual camera” points, ii) of the field of view of the latter (schematized in 36 in FIGS. 2a and 2b), and iii) of its width/height ratio. It is hence defined a “capture area” ZC containing raw pixel data including the raw “useful area” ZU_{B} that will correspond to the field of the “virtual camera” after compensation for the geometric distortions introduced by the fisheye lens.

It will be noted that it is not useful to capture all the pixels of the image I formed on the sensor, but only a fraction of these latter, corresponding to the capture area ZC, for example a window ZC of about 2 Mpixels extracted from an image I of HD quality (1920×1080 pixels), produced by a sensor whose resolution will typically be of 14 Mpixels (4608×3288 pixels). Hence, only the really required pixel data of the capture area ZC are transferred, data that may then be refreshed at a cadence of 30 frames/second with no particular difficulty. A high-resolution sensor can hence be chosen, while keeping a high image flowrate.

Views (a2) and (a3) of FIG. 3 illustrate the processing operations performed on the pixel data of the capture area ZC to obtain the final image compensated for the geometric distortions: based on the pixel data transferred from the capture area ZC (view (a2)), an algorithm extracts the pixel data of the raw useful area ZU_{B} and applies thereto a triangular meshing (technique known in itself) then straightens the image by stretching each triangle, to give a straightened useful image ZU_{R} (view (a3)) with rectified pixel data. The strongly curved horizontal lines of the fisheye image will then be corrected to make them rectilinear and to produce an image corresponding to a natural vision, devoid of geometric distortions.

Views (b1)-(b3) of FIG. 3 are similar to views (a1)-(a3), in a configuration where the attitude of the drone is modified due to the inclination forward of the latter (rotation about its pitch axis), an inclination that follows for example a switching from a still configuration, in hovering flight, to a configuration of moving forward (the linear speed of the drone being all the more great that its inclination is strong).

As illustrated in (b1), to compensate for this downward inclination of the drone, the capture area ZC is moved towards the top of the image, hence in the direction opposite to the inclination of the drone. If the relative position of the raw useful area ZU_{B} remains substantially the same inside the capture area ZC (to allow the following of the scene aimed at), the capture area will on the other hand now include a far more significant part of ground S than of sky C: if then comparing views (a2) and (b2), it is observed that, in the initial configuration (view(a2)), the sky/ground proportion is about 50/50%, whereas in the modified configuration (view(b2)), the sky/ground proportion is about 25/75%. Moreover, is it is strongly displaced upward, the capture area may include areas X that are located outside the region of the circular image formed by the fisheye lens on the sensor.

On the other hand, the final image ZU_{R} of the straightened useful area (view (b3)) will be substantially identical to what is was (view (a3)) before the tilting of the drone forwards.

FIG. 4 illustrates the histograms obtained by analysis of the brightness of the pixels of the thumbnail coming from the capture area ZC, in (a) in the case of view (a2) and in (b) in the case of view (b2), respectively.

As can be seen in this figure, the tilting of the drone forward is translated into a significant modification of the brightness histogram, with an offset towards the left of the mean value M, due to the increase of the ground/sky ratio in the image of the area ZC.

The auto-exposure algorithm will interpret this change of the mean value M as a darkening of the image, which will be automatically compensated by an increase of the time of exposure and/or of the camera sensitivity.

That way, the final images (a3) and (b3) respectively obtained (image of the straightened useful area ZU_{R}), although they display to the user the same framing of the scene, will differ from each other by their exposure setting, the image of view (b3) being clearer than that of view (a3).

The present invention has for object to correct this defect.

FIG. 5 illustrates as a block diagram the different modules participating to the implementation of the invention.

The front camera 14 of the drone delivers a raw image signal corresponding to the image I. This camera, mechanically linked to the drone body, is subjected to angular displacements that are measured by an inertial unit (IMU) 12 linked to the drone body and hence to the camera. The rotations of the camera are given by the pitch angle φ, the roll angle θ and the yaw angle ψ, describing the inclination of the drone in the three dimensions with respect to a fixed terrestrial reference system (Euler angles). These data are applied to an angle prediction module 48 piloting a module of calculation of the position of the capture area ZC in the image I. A video processing module 52 receives as an input the raw image signal I and performs various operations of windowing as a function of the position of the captured area ZC calculated by the module 50, of image stabilization, of extraction and straightening of the useful area, to deliver as an output to the user a useful image signal ZU_{R} to be transmitted to the user, and possibly displayed and recorded.

The module 52 also performs the control (schematized by the return 54) of the camera operation parameters, in particular the control of the auto-exposure (EA), of the white balance AWB and of the automatic focusing AF. The module 52 also ensures the correction, according to the invention, of the above-mentioned defect about the automatic calculation of these camera operation parameters, as will be described hereinafter.

FIG. 6 is a flow diagram explaining the main successive steps of implementation of the invention, in a first and a second embodiment of the latter. This flow diagram 100 comprises an initial step (block 102) of collection of the raw image I by the camera, followed by a step (block 104) of extraction from this raw image of the capture area ZC as a function of the drone attitude data delivered by the inertial unit IMU.

The following step (block 106), characteristic of the invention, consists in an analysis of the image data of the capture area, in the manner that will be exposed in details hereinafter with reference to FIGS. 7 and 8, for the delivery of camera control parameters, in particular the auto-exposure parameter.

The content of the capture area ZC is then subjected to a processing (block 108) of extraction of the raw useful area ZU_{B} and of reprojection of this raw useful area ZU_{B} to give the straightened useful area ZU_{R}, corresponding to the final straightened image delivered to the user.

With reference to FIGS. 7 and 8, two possible embodiments of the data analysis operated by the block 106 will now be described in more details.

By the way, it will be noted that this analysis is performed on the basis of the thumbnail coming from the image initially contained in the capture area ZC (downstream from block 104), before the reprojection step (block 108), hence on a deformed version of the image.

FIG. 7 illustrates the areas of analysis of the capture area according to the first embodiment of the invention, such analysis being operated based on regions of interest ROIs defined automatically inside the thumbnail coming from the capture area.

In this embodiment, the image analysis device defines (according to techniques known in themselves, that won't be described in more details) a plurality of regions of interest ROIs, which are geometrical selections of areas of reduced size in the image to be analysed, a brightness histogram being established for each of these areas. The auto-exposure algorithm analyses and compares the histograms corresponding to the different ROIs and adjusts accordingly the level of exposure, according to techniques of analysis also known by themselves.

Characteristically of the invention, the ROIs are distributed in the thumbnail coming from the capture area so as to be located totally or partially inside the raw useful area ZU_{B}, i.e. if the ROI definition algorithm generates ROIs outside the raw useful area ZU_{B}, these latter will be excluded from the subsequent analysis for the auto-exposure control. In any case, the pixel data located outside the region of the image formed on the sensor by the lens (regions X of the views (b1) and (b2) of FIG. 3) are excluded from the analysis. In other words, the pixels located outside the image circle are ignored for the calculation of the auto-exposure.

Moreover, each of the regions of interest ROI₁ . . . ROIₙ is allocated with a weighting value taking into account the more or less great extent of the overlapping of the concerned ROI with the raw user useful area ZU_{B} defined inside the capture area: the weighting will be maximal for the ROIs entirely included in the area ZU_{B}, null for the ROIs entirely located outside the area ZU_{B} (which comes to exclude them from the analysis), and intermediate for the ROIs partially included in the area ZU_{B} (the weighting being all the more high that the proportion of the surface area of the ROI located inside the area ZU_{B} is high).

FIG. 8 illustrates a second embodiment, in which the ROIs are no longer defined dynamically and with a variable size, but as a regular grid in the thumbnail coming from the capture area ZC, with a grid GR each elementary square or rectangular ROI(I,j) of which will be affected by a variable weighting as a function of its more or less overlapping character with the area ZU_{B}, in the same manner as in the first embodiment, exposed in relation with FIG. 7.

FIG. 9 is a flow diagram explaining the main successive steps of implementation of the invention, in a third embodiment of the latter.

In this third embodiment, the image data analysis is not performed on the thumbnail coming from the deformed, initial version of the image (capture area ZC and raw useful area ZU_{B}) with a weighting applied to each region of interest, but on the thumbnail coming from the straightened image, after the reprojection step.

On the flow diagram 200, the blocks 202 (image collection), 204 (extraction of the capture area ZC) and 206 (extraction and reprojection of the user area) are similar to the respective blocks 102, 104 and 108 of FIG. 6.

On the other hand, the data analysis step for the control of the camera auto-exposure parameters (block 208) is operated downstream from block 206, i.e. on the straightened version of the image. The auto-exposure then operates conventionally (automatic definition of the ROIs, etc.) without it is required to apply to each ROI a weighting value reflecting the position of this ROI with respect to the raw useful area ZU_{B}.

1. A drone (10) comprising:
a camera (14) linked to the drone body, comprising:
a hemispheric-field lens of the fisheye type, pointing in a fixed direction with respect to the drone body; and
a digital sensor collecting the image (I) formed by the lens and delivering raw image data;
an inertial unit (16), adapted to measure the Euler angles (φ, θ, ψ) characterizing the instantaneous attitude of the drone with respect to an absolute terrestrial reference system and delivering as an output current drone attitude data;
extractor means (52), adapted to define, in said image (I) formed over the extent of the sensor, the position of a capture area (ZC) of reduced size;
control means (48, 50, 52), receiving as an input the current drone attitude data and adapted to dynamically modify the position and the orientation of the capture area (ZC) in said image (I) in a direction opposite to that of the changes of values of the angles measured by the inertial unit; and
reprojection means (52), receiving as an input image data of a user area (ZU_{B}) extracted from the capture area (ZC) and delivering as an output corresponding straightened image data (ZU_{R}), compensated for the geometric distortions introduced by the fisheye lens,
characterized in that the camera (14) further includes:
means for the dynamic control of at least one imaging parameter among: auto-exposure, white balance and autofocus,
and in that the drone further comprises:
analysis means, adapted to define in the capture area (ZC) at least one reduced-definition thumbnail, and to deliver (54) a current value of said imaging parameter as a function of the image data contained in said thumbnail; and
compensator means (52), such means receiving as an input the current drone attitude data delivered by the inertial unit and being adapted to dynamically interact with the analysis means, as a function of these current attitude data, in a direction opposite to the variations, liable to be caused by the instantaneous variations of attitude of the drone, of said value of the imaging parameter, delivered by the analysis means,
so as to keep to said imaging parameter a value that is substantially independent of the instantaneous variations of attitude of the drone.

2. The drone of claim 1, wherein the analysis means are further adapted to exclude from said image data contained in the thumbnail coming from the capture area (ZC) the raw image data that are located outside (X) the region of the image formed by the lens on the sensor.

3. The drone of claim 1, wherein the compensator means receive as an input (104) the image data comprised in the thumbnail coming from the capture area (ZC), delivered by the extractor means.

4. The drone of claim 3, wherein:
the analysis means comprise means adapted to define dynamically in each image a plurality of regions of interest ROIs (ROI₁ . . . ROI₇) distributed over the capture area (ZC) with a corresponding thumbnail for each ROI, and to deliver a current value of said imaging parameter for each respective thumbnail; and
the compensator means comprise means adapted to interact dynamically with the analysis means by modification of the size and/or position of the ROIs in the capture area as a function of the current drone attitude data.

5. The drone of claim 4, wherein the compensator means comprise means adapted to previously exclude from the definition of the ROIs those of the ROIs that are located outside the current user area (ZU_{B}) included in the capture area (ZC).

6. The drone of claim 5, wherein the compensator means comprise means adapted to allocate (106) to each ROI a peculiar weighting value that is function of the more or less great extent of the overlapping of the ROI with the current user area (ZU_{B}) defined inside the capture area, this value being maximum for the ROI entirely included in the current user area and lower for the overlapping ROIs extending both inside and outside the current user area.

7. The drone of claim 5, wherein the compensator means comprise means adapted to allocate to each ROI a peculiar weighting value that is function of the more or less great surface of the ROI.

8. The drone of claim 3, wherein:
the analysis means comprise means adapted to define in each image a grid (GR) of regions of interest ROIs (ROI(i,j)) distributed in a uniform and predetermined manner over the capture area (ZC) with a corresponding thumbnail for each ROI, and to deliver a current value of said imaging parameter for each respective thumbnail; and
the compensator means comprise means adapted to interact dynamically with the analysis means by allocating (106) to each ROI a peculiar weighting value that is function of the extent of the overlapping of the ROI with the current user area (ZU_{B}) defined inside the capture area (ZC), this value being maximum for the ROIs included in the current user area, minimum for the ROIs external to the current user area, and intermediate for the overlapping ROIs extending both inside and outside the current user area.

9. The drone of claim 1, wherein the compensator means receive as a input (206) the straightened image data (ZU_{R}), compensated for the geometric distortions introduced by the fisheye lens, delivered by the reprojection means.

10. The drone of claim 9, wherein:
the analysis means comprise means adapted to define dynamically in each image a plurality of regions of interest ROIs distributed over the straightened image (ZU_{R}) with a corresponding thumbnail for each ROI, and to deliver a current value of said imaging parameter for each respective thumbnail; and
the compensator means comprise means adapted to interact dynamically with the analysis means by modification of the size and/or position of the ROIs in the straightened image (ZU_{R}) as a function of the current drone attitude data.
